(19) United States
(12) Patent Application Publication
(10) Pub. No.: US 2026/0019544 A1
(43) Pub. Date: Jan. 15, 2026

(54) AUTO ADJUSTMENT OF TIME-STAMPS FOR LASER PROJECTION TO COMPENSATE FOR NON-CONSTANT DELAYS IN MIRROR POSITION SENSING

(71) Applicant: Maradin Ltd., Yoqne'am Ilit (IL)

(72) Inventors: Matan NAFTALI, Moshav Aloney-Aba (IL); Ran GABAI, Haifa (IL); Gil CAHANA, Herzelia (IL); Gad YEARIM, Haifa (IL); Adi BARAM, Yoqneam (IL); Menashe YEHIEL, Moshav Yogev (IL)

(21) Appl. No.: 19/269,940

(22) Filed: Jul. 15, 2025

Related U.S. Application Data
(60) Provisional application No. 63/671,440, filed on Jul. 15, 2024.

(51) Int. Cl. H04N 9/31

(52) U.S. Cl. CPC H04N 9/3194; H04N 9/3152; H04N 9/3161

(57) ABSTRACT

A laser projection system comprising a MEMS structure including a moving mirror and MEMS motion sensor sensing the moving mirror's position; and/or a photodetector which indicates the moving mirror's actual position by providing, at at least one time t, an output indication of light reflected from the mirror at time t which indicates that the moving mirror has reached p at said time t; and/or a controller which, based on the sensor's time-stamps, provides control signals determining illumination of/which illuminates locations of a display surface with illumination reflected off the moving mirror. The location illuminated within the display surface varies as the mirror moves. The controller estimates a delay, in provision of time-stamps for generation of pixels to be displayed on the surface, by comparing outputs of the sensor and photodetector, and, when controlling timing of the light source's illumination, takes into account/compensates for delay as estimated.

### FIELD OF THIS DISCLOSURE

The present invention relates generally to microsystems, and more particularly to MEMS systems.

### BACKGROUND FOR THIS DISCLOSURE

A system and method for correcting optical distortions when projecting 2D images onto 2D surfaces is described in co-owned U.S. Pat. No. 9,769,444. A system for laser projection, described in co-owned U.S. Pat. No. 11,606,540, converts desired pixel location data into time-stamps and, when embedded into an optical device which incorporates a laser having a laser driver, communicates the time-stamps to the laser driver. Such systems, and/or laser projection systems manufactured by Maradin.co.il, include scanning mirrors and MEMS motion sensors which sense the scanning mirror's position.

State of the art scanning mirrors are described here: www.maradin.co.il/products/mems-mirrors-family/. Typically, electromagnetic and electrostatic actuators are implemented in the MEMS micro-mirrors, to induce its scanning rotation and scanning mode/s. Typically, capacitive sensors, carved into the silicon, generate outputs which represent MEMS micro-mirror movement and may be used to control scanning mode/s at a high level of precision. The disclosures of all publications and patent documents mentioned in the specification, and of the publications and patent documents cited therein directly or indirectly, are hereby incorporated by reference, other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

Materiality of such publications and patent documents to patentability is not conceded.

### SUMMARY OF CERTAIN EMBODIMENTS

Certain embodiments seek to provide automatic control of temperature-dependent timing parameters for laser beam scanning displays which, it turns out, vary as a function of temperature. Delay in position and/or speed sensing signals of the mirror, with respect to the mirror's actual position, is typically controlled.

Certain embodiments seek to provide a photodetector serving a given light engine. A light engine typically comprises a MEMS mirror, and/or lasers and/or optics typically integrally formed and/or assembled in a single structure. The photodetector may then be used to facilitate calibration of Pdelay or Pixel delay or a delay of position and/or speed sensing signals of the mirror with respect to the mirror's actual position; this may be estimated using comparison between an external (e.g. not carved into silicon) optical sensor or photodiode and a MEMS motion sensor (typically carved into the silicon). The photodetector may, for example, be located within the light engine.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Thus the present invention typically includes at least the following embodiments:
Embodiment 1. A laser projection system comprising a. a MEMS structure typically including a moving mirror/s and/or at least one MEMS motion sensor which senses the moving mirror's position; and/or b. a photodetector/s which typically indicates the moving mirror's actual position e.g. by providing, at at least one time t, an output indication of light reflected from the mirror at time t which typically indicates that the moving mirror has reached a certain position p at the time t; and/or c. a controller which, based on the sensor's time-stamps, provides control signals determining illumination of/which illuminates various locations of a projection surface aka display surface e.g. screen with illumination reflected off the moving mirror, wherein the location illuminated, within the display surface, varies as the mirror moves. Typically, the controller estimates a delay in provision of time-stamps for generation of pixels to be displayed on the projection surface, by comparing outputs of the MEMS motion sensor and of the photodetector, and, when controlling timing of the light source's illumination, takes into account or compensates for the delay as estimated.
Embodiment 2. The system according to any of the preceding embodiments wherein controlling timing of the light source's illumination, which takes into account the delay as estimated, comprises generating a time-stamp, by a controller, at which the light source is commanded to generate a given pixel, while taking into account the delay as estimated including using the sensor's output as an estimate of the moving mirror's position over time; this estimate is typically independent of the sensor.
Embodiment 3. The system according to any of the preceding embodiments wherein the display surface comprises an array of pixels comprising rows and columns and wherein the moving mirror, which pivots, has roll in which the mirror pivots backward and forward about at an axis corresponding to a vertical midline of the display surface, defining an extreme backward position and an extreme forward position respectively corresponding to the two vertical sides (right and left edges e.g.) of the display surface, such that when the mirror is in its extreme backward position, illumination reflected therefrom illuminates a pixel in the right-most column of the display surface, and when the mirror is in its extreme forward position, illumination reflected therefrom illuminates a pixel in the left-most column of the display surface.
Embodiment 4. The system according to any of the preceding embodiments wherein the display surface comprises an array of pixels comprising rows and columns, and wherein the moving mirror, which pivots, has pitch in which the mirror pivots backward and forward about at an axis corresponding to a horizontal midline of the display surface, defining an extreme backward position and an extreme forward position respectively corresponding to the top and bottom horizontal edges of the display surface, such that when the mirror is in its extreme backward position, illumination reflected therefrom illuminates a pixel in the topmost row of the display surface, and when the mirror is in its extreme forward position, illumination reflected therefrom illuminates a pixel in the bottom-most row of the display surface e.g. screen.
Embodiment 5. The system according to any of the preceding embodiments wherein the MEMS structure also comprises an optical cover which covers the mirror as a reflecting surface and wherein a portion of light impinging upon the optical cover is reflected back thereby to define cover-reflected light, and wherein the photodetector is positioned to receive the cover-reflected light at at least one time t, and, accordingly, to provide an output indication at time t which indicates that the moving mirror has reached, at time t, a position which causes the cover-reflected light to reach the photodetector.

It is appreciated that, e.g. to protect the MEMS/Lasers//Optics, the optical cover may comprise an optical window on the light engine (e.g. as shown in FIG. 7) and/or on the MEMS (e.g. as shown in FIGS. 5-6).

It is appreciated that the optical cover normally has an anti-reflective coating; nonetheless the coating is not 100% effective, thus a non-zero portion of the light impinging upon the optical cover is reflected back, rather than arriving at the projection surface, e.g. display screen.
Embodiment 6. The system according to any of the preceding embodiments wherein the controller computes a difference of d millisec between time t at which the photodetector identified that the moving mirror has reached position p and a time-stamp at which the sensor indicates that the moving mirror has reached position p, and adds a bias of d millisec to the control signals that the controller provides to the light source.
Embodiment 7. The system according to any of the preceding embodiments wherein the photodetector comprises a photodiode.
Embodiment 8. The system according to any of the preceding embodiments wherein the surface Illumination controller comprises a video controller which computes a time stamp T for each pixel and, accordingly, controls data flow e.g. by causing a laser driver to generate, at time T, a pixel whose value corresponds to a stored pixel value.
Embodiment 9. The system according to any of the preceding embodiments wherein the light source comprises a laser.
Embodiment 10. A laser projection method comprising a. providing a MEMS structure including a moving mirror/s and/or at least one MEMS motion sensor which senses the moving mirror's position; and b. providing and/or using a photodetector to indicate the moving mirror's actual position e.g. by providing, at at least one time t, an output indication of light reflected from the mirror at time t which typically indicates that the moving mirror has reached a certain position p at the time t; and/or c. providing and/or using a controller which, based on the sensor's time-stamps, provides control signals determining illumination of/which illuminates various locations of a projection surface aka display surface e.g. screen with illumination reflected off the moving mirror, wherein the location illuminated, within the display surface, varies as the mirror moves. Typically, the controller estimates a delay in provision of time-stamps for generation of pixels to be displayed on the projection surface, by comparing outputs of the MEMS motion sensor and of the photodetector and, when controlling timing of the light source's illumination, takes into account or compensates for the delay as estimated.
Embodiment 11. The system according to any of the preceding embodiments wherein delay of position and/or speed sensing signals of the mirror with respect to the mirror's actual position is automatically calibrated.

Typically, a routine is provided according to which, fixed or constant delay (e.g. photodetector delay and/or lasers' rise time delay) are automatically calibrated e.g. upon commanding the controller for factory setup.
Embodiment 12. The system according to any of the preceding embodiments wherein light arriving at the photodetector is reflected from the light engine's optical window.

The terms “cover” and “window”, both of which are intended to include generally transparent members or elements which mechanically protect the MEMS/Lasers//Optics, may be interchanged herein. For example, as shown and described elsewhere herein, on the MEMS there may be an optical “cover” (or window) and/or there and may be an optical “cover” (or window) on the light engine. It is appreciated that some light may be reflected from such a window or cover, even if an anti-reflective coating is provided, although typically much less light than is transmitted through the window or cover which is generally transparent.
Embodiment 13. The system according to any of the preceding embodiments wherein delay in position and/or speed sensing signals of the mirror relative to the mirror's actual position is controlled by at least the MEMS Controller.
Embodiment 14. The system according to any of the preceding embodiments wherein delay in position and/or speed sensing signals of the mirror relative to the mirror's actual position is controlled (e.g. estimated/computed, then compensated for/taken into account) by at least the video controller, thereby to provide closed-loop control.
Embodiment 15. The system according to any of the preceding embodiments wherein the moving mirror translates along a linear path.
Embodiment 16. The system according to any of the preceding embodiments wherein the photodetector is located within MEMS packaging encasing a silicon chip which comprises a MEMS structure implementing at least the mirror of the laser projection system.
Embodiment 17. The system according to any of the preceding embodiments wherein the photodetector is part of a silicon chip which comprises a MEMS structure implementing at least the mirror of the laser projection system.
Embodiment 18. The system according to any of the preceding embodiments wherein light arriving at the photodetector is reflected from the MEMS package optical window or cover.

Typically, the MEMS structure includes a silicon structure of a device, whereas MEMS Package typically comprises an addition to the MEMS structure. Typically, a hybrid is attached to the MEMS structure, which may, for example be formed of a plastic or a metal.

### BRIEF DESCRIPTION OF THE DRAWINGS

Certain embodiments of the present invention are illustrated in the following drawings:

FIGS. 1-4 and 7 illustrate embodiments of the invention.

FIGS. 3a-3b describe example implementations e.g. of the embodiment of FIG. 2.

FIG. 5 illustrates an embodiment in which a photo-diode is part of a silicon chip which comprises a MEMS structure implementing at least the mirror of the laser projection system.

FIG. 6 illustrates an embodiment in which a photo-diode is located within MEMS packaging encasing a silicon chip which comprises a MEMS structure implementing at least the mirror of the laser projection system.

The illustrated embodiments may be provided separately or in any combination.

Methods and systems included in the scope of the present invention may include some (e.g. any suitable subset) or all of the functional blocks shown in the specifically illustrated implementations by way of example, in any suitable order, e.g. as shown.

Computational, functional or logical components, described and illustrated herein, can be implemented in various forms, for example, as hardware circuits such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware, such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer, or, more generally, by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include, within the scope of the embodiments of the present invention, also any software or computer program performing all or any subset of the method's operations, including a mobile application, platform or operating system, e.g., as stored in a medium, as well as combining the computer program with a hardware device to perform all or any subset of the operations of the method.

### DETAILED DESCRIPTION OF CERTAIN EMBODIMENTS

Certain embodiments provide a laser projection system which comprises:
a. a MEMS structure including a moving mirror and at least one MEMS motion sensor which sense the moving mirror's position; and/or
b. a photodetector which indicates the moving mirror's actual position by providing, at at least one time t, an output indication of light reflected from the mirror at time t which indicates that the moving mirror has reached a certain position p at the time t; and/or
c. a controller which, based on the sensor's time-stamps, typically provides control signals determining illumination of/which illuminates various locations of a projection surface aka display surface e.g. screen with illumination reflected off the moving mirror, wherein the location illuminated, within the display surface, varies as the mirror moves.

Typically, the controller estimates a delay, in provision of time-stamps for generation of pixels to be displayed on the projection surface, by comparing outputs of the MEMS motion sensor and of the photodetector, and, when controlling timing of the light source's illumination, takes into account or compensates for the delay as estimated.

The delay may be temperature-related delay (e.g. pDelay).

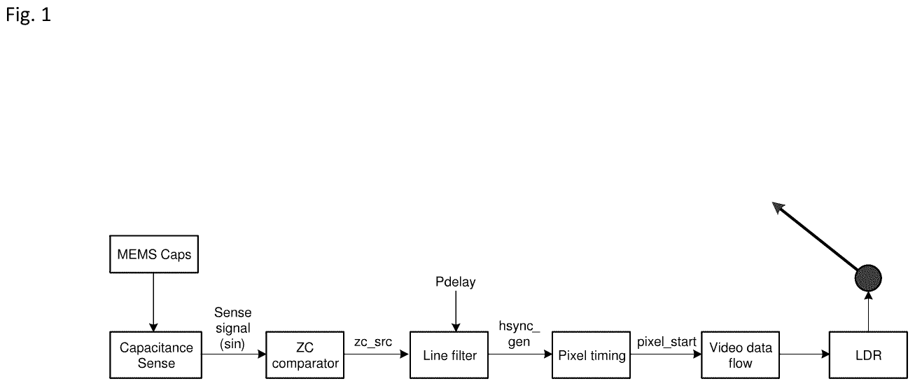

According to certain embodiments, the control signals are fed back to the timing computing or pixel timing block, e.g. as in the embodiment of FIG. 1.

Regarding the photodetector aka optical sensor and motion sensor, it is appreciated that the motion sensor typically comprises a capacitive (e.g. not optical) sensor which may detect the mirror (and typically time-stamps when this detection occurred), by measuring changes in the capacitance of an electric field that occurs when the mirror, which is typically conductive, enters the sensor's detection area. Capacitive sensors can even detect a non-metallic object which has a specific dielectric constant.

In contrast, the photodetector is typically an optical sensor which detects light arriving from the mirror, thus is corelated to a specific mirror position, and generates an electrical signal that varies with respect to the time the light pass occurred, based on presence vs. absence and/or distance and/or shape and/or color, of light.

The photodetector may time-stamp a time at which this light is detected and/or time at which this signal is generated.

Typically, motion sensors are carved into the silicon and the photodetector is external to silicon.

It is appreciated that, typically, the photodetector is positioned to sense light reflected from the optical cover when the moving mirror reaches a specific position p and is thus reflected at a certain angle, and does not sense light reflected from the optical cover unless the moving mirror is indeed in position p. Thus the photodetector is a reliable (e.g. non-temperature dependent) indicator that the mirror has reached position p, however the photodetector is not able to indicate when the mirror is reaching any position other than p. In contrast, the sensor's outputs are deficient in that the outputs suffer from non-fixed delay (the variability of which may be temperature dependent), however the sensor's outputs are still used by the controller as the only indication of when the mirror reaches each position other than p. The deficient sensor's outputs are enhanced by compensating for the non-fixed delay.

The bias, aka Pdelay value used to compensate for the sensor's non-fixed delay, may be computed at least once per cycle of motion of the mirror. Typically, the mirror has a cycle of motion from one end-position to another; if the photodetector is positioned to receive light reflected when the mirror is at one of the end-positions, then the photodetector receives light once per cycle, whereas if the photodetector is positioned to receive light reflected when the mirror is at a position other than its end-positions, then the photodetector receives light twice per cycle. In this latter case, the bias, aka Pdelay for each cycle of mirror motion, may be computed by combining e.g. averaging the two delays computed the first and second times that the photodetector receives the cover-reflected light, or alternatively, the bias, aka Pdelay, may be computed twice per cycle of mirror motion, once based on delay computed the first time that the photodetector receives the cover-reflected light, and again based on delay computed the second time that the photodetector receives the cover-reflected light.

Typically, each photodetector has some delay which is fixed or constant and (assuming the light source is a laser) each laser diode itself has a non-zero rise-time and fall-time which also cause delay. Typically, three colors of laser diode (e.g. r, g, b) are employed and each has its own non-zero rise-time and fall-time. Also, each manufacturer's laser diode tends to have a rise-time and fall-time which differs from other manufacturers' rise-times and fall-times. Even the length of cable connecting the laser drivers to the laser diodes, in laser projection use-cases of the embodiments herein, can affect the durations of rise-time and fall-time. However, all of these are typically not temperature-dependent and can therefore be handled by in-factory calibration, per machine or per batch of machines coming off a given assembly line, of a baseline value for the bias aka Pdelay. The bias value, computed typically twice per cycle, may be algebraically added to the baseline bias value computed in the factory.

It is appreciated that, more generally, the moving member in the MEMS structure need not necessarily be a mirror. Motion may, for example, be linear, or may be a pivoting or rotational motion.

It is appreciated that the MEMS motion sensor (e.g. MEMS Caps in FIG. 1) due to delay which is not constant, and may instead be ambient temperature-related, provides time stamps for respective moving mirror's positions which may be respectively delayed relative to times at which the moving mirror is actually in the respective positions.

Typically, the output of the MEMS motion sensor goes to the MEMS controller and from there to the video controller. The PD (photodetector output) signals reach the video controller. Alternatively, a single controller may perform the functionalities of the MEMS and video controllers.

According to certain embodiments, the output of the MEMS motion sensor goes to the MEMS controller, and from there to the video controller.

According to certain embodiments, the MEMS position sensor (e.g. MEMS Caps in FIG. 1) feeds its output to the MEMS controller (e.g. blocks ZC/line filter/data flow in FIG. 1) and only then to the laser driver, e.g., LDR.

Certain embodiments seek to reduce a source of inaccuracy in image pixels generated by laser projection system caused by the fact that pixel timing and location are a function of scanning mirror location (e.g. angular location along the x and y dimensions determine pixel location along the images x and y axes, for a pivoting mirror), combined with the fact that MEMS motion sensors do sense mirror location, however it turns out that delays in outputs of the MEMS motion sensors create a situation whereby the correct location of the mirror is provided to the pixel timing control for the laser driver with some delay compared to when the mirror location was actually sensed, i.e. at a time at which the location of the mirror, which was correct when sensed, is no longer correct. Thus, embodiments herein seek to compensate for the fact that the pixel timing control is, due to this delay, in effect systematically mis-informed as to the actual current location of the mirror. Such compensation is non-trivial, given that it turns out that the delay which is causing this mis-information in the first place, is not constant, and instead varies over time, e.g., as a function of ambient temperature.

Given a MEMS laser projection system, certain embodiments add a photodetector which is positioned to detect at least a portion of an incident beam (e.g. positioned to detect a portion of the incident beam, which, due to the imperfect anti-reflective coating on the scanning mirror's project window, is reflected back from the window, rather than passing through the window) and is also typically positioned so as not to block the laser projector's field of view, thus avoiding any detraction of image quality. The output of the photodetector may be used to derive an additional estimate of at least some scanning mirror locations (e.g. of extreme scanning mirror locations along the scanning mirror's x and/or y axes) for comparison with a current estimate of the scanning mirror's location (i.e. two estimates, generated at the same time, of the scanning mirror's location, may be compared). From this comparison, an estimate of the delay which is causing mis-information as described above, may be derived. Thus, an FPGA (or micro-controller or any other computational component), may be configured to convert photodetector output into an estimated pixel delay signal, Pdelay. Once this estimate is available in real time, it is then possible to compensate in real time for the fact that the pixel timing control is, due to this delay, effectively mis-informed, by commanding that a pixel value be generated at a time which takes into account the true position of the mirror, available by adjusting the estimated position of the mirror available from the motion sensor, by a number of mm or radians corresponding to the estimated delay interval (in time) given the known (angular e.g.) speed of the scanning mirror. To achieve compensation, the controller may generate a time-stamp at which a light source generates a pixel, which compensates for anticipated delay by generating an earlier time-stamp than would be required were there zero delay, to generate a pixel value (typically stored for each mirror position) which is to be presented at a given time t.

Typically, the controller generates a time-stamp for each pixel by estimating or predicting the time T (aka estimated next-pixel-time) at which the mirror will reach a position which corresponds to a desired location of the next pixel on the projection surface e.g. display screen. From this estimated next-pixel-time, the controller may, e.g. when generating the time-stamp for the next pixel, subtract the Pdelay value as currently estimated, such that the stored pixel value is generated by the laser driver at a time (time-stamp) which precedes the estimated next-pixel-time by Pdelay seconds. As a result of this compensation, the pixel generated before the estimated next-pixel-time as described above is, due to the delay, actually projected at the estimated next-pixel-time.

The controller may, for example, have a LUT (look-up-table) which associates certain mirror position with certain pixel locations on the display surface. The controller then commands the laser to generate the next pixel value at time-stamp T. According to certain embodiments, the estimate of T is generated by comparing the outputs of the mirror sensor and the photodetector, determining delay accordingly, then estimating T accordingly.

Typically time-stamps, on which to modulate the lasers, are computed.

These time-stamps are initially calibrated (e.g., factory setup) according to the projection geometry, and are then fine tuned as the MEMS are operated, by measuring the actual movement of the MEMS. Calibration may take into account delay in time-stamp computation, however if the delay changes (e.g. due to temperature) this causes inaccuracy e.g. deviation from desired pixel laser timing.

This compensation facilitates more accurate aligning of pixels in forward and backward lines. It is appreciated that lines of pixels form an image on a projected surface. Some of these lines (e.g. the odd numbered vertical lines) are generated as the mirror moves forward, until the mirror reaches its extreme forward position (corresponding, say, to the projection surface's right-most column), and alternating (e.g. even numbered vertical) lines are generated as the mirror moves e.g. pivots back, until the mirror reaches its extreme backward position ((corresponding, say, to the projection surface's left-most column), at which point the mirror again begins to move forward.

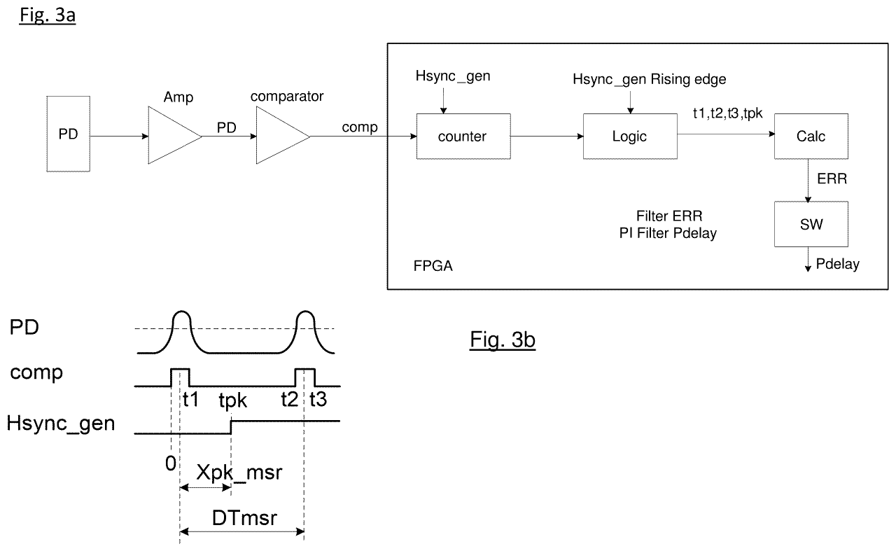

However, it turns out that Pdelay is not constant, being instead temperature dependent, e.g. due to temperature-related variability in operation of the analog sense circuits e.g. of the MEMS position sensor aka motion sensor (represented as “MEMS caps” in FIG. 1). Thus, according to certain embodiments, Pdelay may be automatically adjusted online using suitable signals e.g. as described below, with reference to FIG. 3a inter alia, and/or the system may compensate the Pdelay as automatically adjusted online, in the line filter block of FIG. 1. This compensation is advantageous relative to conventional video controllers in laser projection systems which store Pdelay as a fixed parameter or constant in a register, and substitute closed circuit control, e.g., as described above.

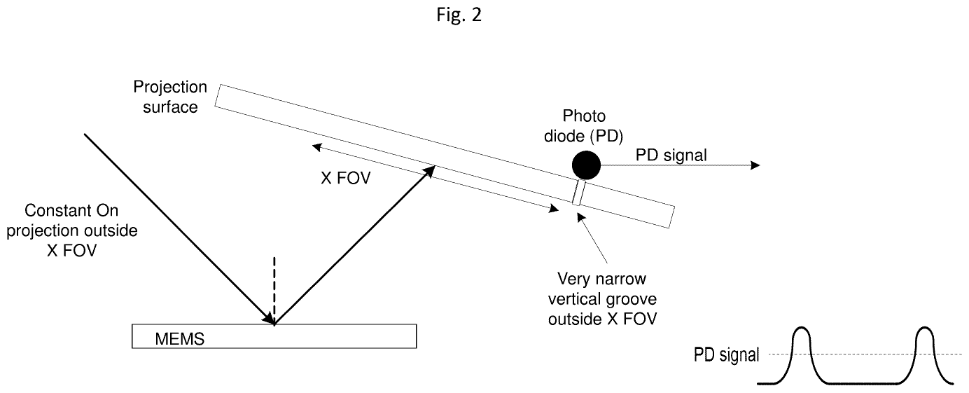

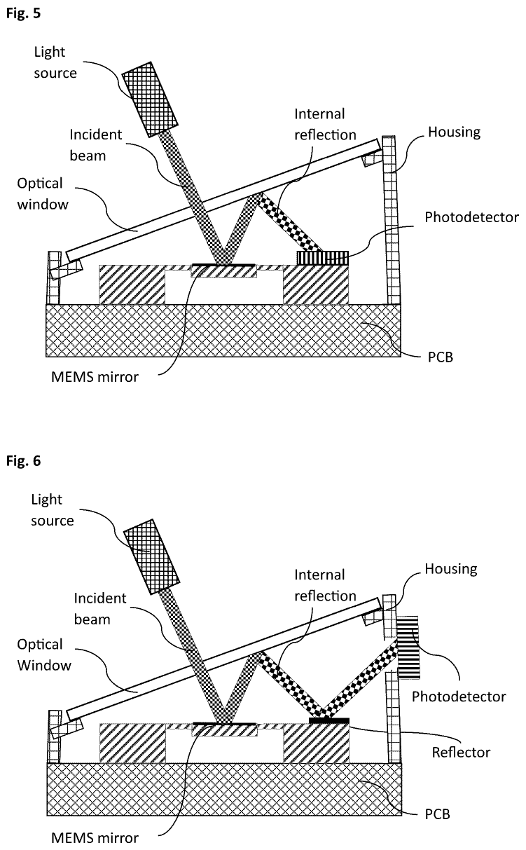

The photodetector may be in any suitable location e.g. on the mirror/MEMS as in FIG. 5 or on the housing aka “device cover” aka packaging as in FIG. 6, or even on the display screen or behind the display screen (e.g. if the laser projector is on one side of the projection surface, the photodetector may be on the opposite side, e.g. if a hole is made in the display screen, as in FIG. 2). A mechanical support (e.g. housing or packaging) which supports mirror, lasers, and lenses may be utilized, according to certain embodiments, to support the photo-detector.

FIG. 1 is an example implementation of a laser projection system which is an example use-case for embodiments herein such as that described above. According to certain embodiments, closed loop control of Pdelay, which is temperature-dependent, is provided, rather than storing Pdelay as a fixed value or constant in a register.

In FIG. 1, MEMS structure capacitors (MEMS Caps) serve as MEMS motion sensors. As the MEMS device, e.g., mirror, moves, e.g., rotates, or pivots, or translates linearly, the capacitance changes, and, physically there is voltage change corresponding to this capacitance change. Translation to voltage change occurs at the “Capacitance sense” block of FIG. 1; for an oscillating mirror, this voltage signal is a sine signal. Then, to get a position-time correlation of the MEMS, the voltage passes through a comparator that compares the voltage level of the sense signal or signal as sensed by the MEMS motion sensor/s, to a certain voltage level correlated to the MEMS position. Assuming that the MEMS device is a rotating mirror, the voltage level correlates to the zero rotating angle of the MEMS (aka: zero cross or ZC). A digital signal (ZC_SRC) emerges from the ZC comparator and enters a filtering block (“line filter”) which typically comprises a memory based filter that may utilize previous data to average the signal and reduce noise. The output signal of the “line filter” block may then serve as the reference for the laser modulation block of FIG. 1 (Pixel timing).

Thus, according to certain embodiments, an inherent motion sensing signal is provided that describes a certain position of the MEMS (in this case, ZC or zero crossing), a signal conditioning/filtering circuit (“line filter”) and a timing block that takes the MEMS position and generates, according to a suitable algorithm, e.g., as described herein or as known in the art, the MEMS position. It is appreciated that this arrangement may be useful for any MEMS oscillator/sensor where the desired location of the MEMS is sought, in high precision, in real time.

The line filter block may, alternatively or in addition, “correct” or compensate for delay of (e.g. accruing from) the previous blocks, typically using the Pdelay correction signal, yielding an Hsync_gen signal for laser modulation. The laser modulation for each pixel is computed, providing reference of geometry and algorithms that take into account the MEMS kinematics, yielding a time-stamp (“pixel_start”) at which the laser should be turned on for each pixel (i.e., pixel start). The video data flow block gets the video content (typically comprising pixels to be displayed on the projection surface) from a display buffer (not shown) and sends pixel values to the laser driver at the correct timing (e.g. “pixel_start”, preferably with compensation) as computed at the pixel timing block. It is appreciated that timing is correct to the extent that timing is correlated to exact mirror position since the pixels' locations on the projecting surface are a function of the mirror's position.

The “video data flow” and “pixel timing” blocks in FIG. 1 may be (functional) components in the video controller. They may be implemented as microcontrollers or FPGAs; typically, the “video data flow” and “pixel timing” blocks may be within the same microcontroller or FPGA, e.g., that which is shown in FIG. 3a.

FIG. 2 shows an apparatus which enables Pdelay to be derived from measurements of Photo Detector (PD), responsive to light from the scanning mirror. In the illustrated embodiment, this light is shown to penetrate through a tiny hole or very narrow groove, say a few mm in diameter, such as 1-3 mm in diameter, located close to the end or edge of (say, 3% of the way along) X-FOV (e.g. the horizontal dimension of the light source e.g. laser projector's field of view) in the projected plane. This occurs while the MEMS device (such as a MEMS Scanning Mirror e.g. MAR1110.X, MAR1200, typically in conjunction with a MEMS Controller, aka mirror controller such as MAR2200, MAR2220, MAR2300, MAR4400 and/or a video controller such as MAR3200) is moving at resonance (e.g. at its resonance frequency). However, this is merely one possible light path which will enable the photodetector to detect light from the scanning mirror without interfering with the laser projector's field of view, thus without detracting from image quality. Any suitable light path may be employed instead e.g. as shown in FIGS. 5 and 6.

The apparatus of FIG. 2 yields two pulses e.g. when the MEMS is close to one side or edge of the moving member's X motion typically at a deterministic Y position. A comparator (see e.g. FIG. 3a) may generate two pulses (e.g. edges of the photodetector's output signal (e.g. the COMP (comparator output) signal of FIGS. 3a-3b) from the photodetector output, that will be directed to a microcontroller or FPGA for processing. The center between those two pulses is typically the peak actual position of the MEMS moving mirror.

The MEMS of FIG. 2 may comprise the scanning mirror of FIGS. 5-6, or may include a MEMS structure other than a mirror.

FIGS. 3a-3b describe an example implementation of the embodiment of FIG. 2. In FIGS. 3a-3b, the comparator typically compares the PD signal to a reference voltage level (ref. level). When the PD signal increases past the reference voltage level, this yields a rising edge of the COMP signal, and when the PD signal falls below a reference voltage level, this yields a falling edge of the COMP signal. This photodetector typically has two peaks of its electrical output signal (“comp”, in FIGS. 3a-3b e.g.), one occurring during forward motion of the mirror, the other occurring during backward motion of the mirror. The two peaks are also termed herein pulses (rising and falling edges e.g. of the COMP (comparator output) signal of FIGS. 3a-3b).

The terms “photodetector” (e.g. photodiode) and “optical sensor” may be interchanged in this disclosure, mutatis mutandis.

Hsync_gen, in FIG. 3b, is the output of the line filter of FIG. 1.

Gen means Generated (as opposed to other possible Hsync signals which may be derived computationally in various ways) where HSYNC is a signal that is typically correlated to horizontal scan specific position (i.e., line start) and may be used as a time datum for all pixels' time-stamps per line.

The FPGA in FIG. 3a (or microcontroller) may be included in or incorporated into the video controller of the laser projection system.

Typically, Hsync_gen signal provides measurement of the peak position of the MEMS; see e.g. FIG. 1. The Hsync_gen signal is typically generated from MEMS capacitance position sensor measurement, a ZC (zero cross) comparator that measures the normal position of the MEMS in real time (normal position is defined as the position of the MEMS without activation) and generates ZC_src signal, and a line filter module that filters that ZC_src signal line by line, and generates filtered peak position Hsync_gen. “Peak position” is intended to include the position of the MEMS at its peak, which in sinusoidal motion profile occurs at a point equidistant from two adjacent normal positions. The filtered peak position Hsync_gen takes into account system delay (see FIG. 1, e.g.) from MEMS capacitance sensor up to LDR projection, by a parameter called Pdelay. The larger the propagation delay from MEMS cap sensor to the actual projection, the larger is Pdelay. Any change in system delay during normal operation may be compensated by change in the Pdelay parameter to keep Hsync_gen accurate.

The Hsync_gen signal is used as a reference to pixel activation timing (with reference e.g. to the pixel timing block of FIG. 1). Any time error in Hsync_gen may shift pixel projection accordingly, e.g., may shift forward pixels forward, and may shift backward pixels backward. Therefore, when projecting during forward and backward, any time error in Hsync_gen is typically doubled in appearance, as forward projected pixels and backward projected pixels are shifted in opposite directions. The pixel timing module generates a pixel_start pulse for each pixel. This pixel_start pulse may trigger the drive of a video pixel data to the laser driver (LDR) that drives programmable current to the laser diodes.

The system herein is typically configured to accurately measure or derive the peak position of the MEMS, from PD (Photo Detector) sensing, e.g. by using the following algorithm or computation:
A comparator (FIG. 3a) generated two digital pulses from PD signal.

A counter is reset at the beginning of the 1^{st} pulse, and measures: (see e.g. FIG. 3b) t1=1st pulse width; and/or t2=2^{nd} pulse start time and/or t3=2^{nd} pulse end time and/or tpk=Hsync_gen peak time

The time between the centers of the two PD pulses is then

$$DTmsr = t 3 - ( t 3 - t 2 ) / 2 - t 1 / 2 = ( t 3 + t 2 - t 1 ) / 2$$

The time of Hsync_gen peak position relative to the center of the first PD pulse is then:

$$Xpk\_msr = tpk - t 1 / 2$$

The PD circuit delay (PD delay plus comparator delay, from FIG. 3a), may be subtracted from DTmsr to yield the actual peak time measured by the PD.

The delay of the video data flow and the delay of the LDR may be added to Xpk_msr to yield the time of projection according to Hsync_gen peak signal.

The peak position time measured by the PD is: (DTmsr/2)−PD_circuit_delay

The peak position time from Hsync_gen peak signal is:

$$Xpk\_msr + Video\_Data \_flow delay + LDR delay$$

If DLY=PD_circuit_delay+Video_data_flow delay+LDR delay

Then:

$$ERR = DLY + Xpk\_msr - DTmsr / 2$$

The ERR is typically adjusted to zero by controlling the Pdelay parameter, which directly controls Hsync_gen which in turns controls Xpk_msr time.

Thus, the algorithm of FIG. 3a may be used to extract the two centers of the two pulses (typically edges of the photodetector's output signal (e.g. the COMP (comparator output) signal of FIGS. 3a-3b) respectively. These pulses have centers by definition because of their being sinusoidal.

Pdelay setting during normal operation typically includes all or any subset of the following, in any suitable order e.g. as follows:
a. DTmsr=t3−(t3−t2)/2−t1/2=(t3+t2−t1)/2, where t1, t2 and t3 are shown in FIG. 3
b. Xpk_msr=tpk−t1/2, where tpk (and t1) are shown in FIG. 3b.
c. compute (calc in FIG. 3a): ERR=Xpk_msr+DLY−DTmsr/2, where DLY is the sum of Data flow delay, LDR delay and PD_delay (photodetector delay)

Pdelay is a value which may be used to compensate the entire (total) delay from MEMS position sensor till actual projection. Typically, if the MEMS is physically located at its normal position, without any delay compensation, the projection may be delayed by Pdelay time. To project at normal position, the reference signal generated by the line filter (Hsync_gen) is typically preceded by Pdelay parameter (or the reference signal or Hsync_gen may be generated by the line filter Pdelay seconds earlier.

PD_delay is the photodetector delay which may be used in the calibration method defined here.

Data flow delay plus LDR delay is the delay from Hsync_gen signal till actual projection by the laser.

The sum of these values (PD_delay+data_flow delay+LDR delay) is defined as DLY.

In the calibration process described herein, ERR (e.g. the difference between peak projection measure by the photo detector and the sum of DLY plus Xpk_msr) may be measured, and ERR may be controlled to achieve a zero value by adjusting the Pdelay parameter.

Regarding data flow delay, to achieve the exact pixel information, the video data flow block of FIG. 1 performs several operations which typically require, in total, several clock cycles. The consequent delay in time of, typically, several clock cycles (aka the “Data flow delay”) is typically fixed or constant, thus typically does not change as a function of temperature or MEMS frequency.

The video data flow block of FIG. 1 typically retrieves data stored in a display buffer for each pixel, and sends this retrieved data to the laser driver according to the time-stamp of the pixel. Thus, for example, for pixel I, J the video data flow block may send the pixel data (color and intensity) when the exact time-stamp for pixel I, J arrives.
d. Filter ERR (in embedded software, or in hardware) typically along plural e.g. several frames e.g. using a BiQuad filter (second order (two poles and two zeros) IIR filter.)
e. Change Pdelay (in embedded software, or in hardware) using PI filter to get zero error (“ERR”). The PI filter may include a shunt capacitor at the input side, followed by an L-section filter. Rectifier output may be directly given across the capacitor. Pulsating DC output voltage may be filtered first by the capacitor connected at the input side, then by the choke coil, and then by another shunt capacitor.

Typically, PD delay is fixed or constant, but may need calibration, e.g., due to variability in circuit response/s of the photodetector PD and/or its amplifier.

Typically, closed loop control is provided, e.g., if ERR is positive, increase Pdelay. If negative, reduce Pdelay.

Still with reference to FIG. 3a, all measurements (counter-clock) may be done, say with 150 Mhz, although this is not intended to be limiting.

It is appreciated that Hsync_gen edge may be a rising or falling edge, depending on PD (photodetector) position.

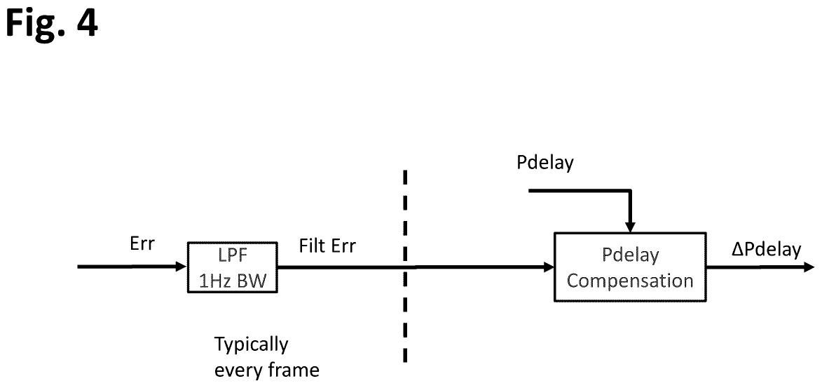

FIG. 4 is a diagram of a compensation process e.g. Error (“err” or ERR) minimization algorithm which may be used in conjunction with all or any subset of the embodiments of FIGS. 1-3b (when implemented in SW). LPF denotes a “low pass filter” which may be used to filter the err signal arriving from the calc block of FIG. 3a. The compensation process of FIG. 4 typically runs every frame e.g. every n frames, where n=1.

As described above, Err=Xpk_msr+DLY−DTmsr/2

Err is typically the measured value of the error, e.g. on every video projected frame. The LPF may filter this Err value every frame, and may generate filtered value Err_filt every frame.

The Pdelay compensation algorithm by which the “compensation” block in FIG. 3 configures pdelay iteratively may be:

$$P delay ( i ) = Pdelay ( i - 1 ) + K\_p \times ( Err\_filt ( i ) - Err\_filt ( i - 1 ) ) + K\_I \times Err\_filt ( i )$$

### Where:

i is the frame index.

K_p and K_i (aka Kp and Ki respectively—proportional and integrational coefficients of PDelay control loop respectively) typically provide Pdelay tracking, to compensate for Pdelay shift due to, say, temperature.

Typically, there is no calibration for Kp and Ki.

In FIG. 4, pdelay is a value that the compensation block receives, e.g. from the s/w block of FIG. 3a, and delta-pdelay is generated by the compensation block; according to certain embodiments,

$$delta - pdelay = Pdelay ( i ) - Pdelay ( i - 1 ) .$$

It is appreciated that, typically, as shown in FIG. 4, Pdelay is an input to the s/w (to its compensation block) and, as shown in FIG. 3b, Pdelay is also an output of the s/w because the compensation algorithm generates Pdelay(i+1) as an output (e.g. as shown in FIG. 3b) for the next frame from Pdelay(i) and Err_filt(i) and Err_filt(i−1), where i is the current frame, i−1 is the previous frame and I+1 is the next frame.

Example: MEMS member is a pivoting mirror whose actual azimuthal position is currently, say, at the center (normal), but projection to the center is delayed by Pdelay. The delay in actual light projection may be caused by the sense electronics and logic.

Conventionally, DLY is typically calibrated when the system, which arrives from the factory with a factory setting, first runs in the field, and/or when the MEMs+electronics are assembled and the same value may then be re-used, unless the temperature changes substantially, which may necessitate re-calibration.

It turns out that this DLY calibration (e.g. as described herein with reference to FIGS. 3a-3b) typically yields an accurate value for DLY, assuming the temperature, which prevailed during calibration, remains unchanged, which typically is not the case.

However typically, even after calibration, Pdelay tends to drift away from its calibrated value, e.g. due to changes in the ambient temperature.

Typically, a timing generator (e.g. TCB) in a timing CPU (not shown) computes time-stamps on which to modulate the lasers. Typically, the TCB as timing generator is configured for computing that sets time-stamps for the laser input aka “data”. These time-stamps are initially calibrated (e.g., factory setup) according to the projection geometry, and then fine tuned as the MEMS are operated, by measuring the actual movement of the MEMS. Calibration may take into account delay in time-stamp computation, however if the delay changes (e.g. due to temperature) this causes inaccuracy, e.g., deviation from desired pixel laser timing.

Typically, a Comparator (e.g. the comparator of FIG. 1) generates two pulses (rising and falling edges) from the PD (photodetector output) signal generated by the photodetector. These two pulses may be fed to and processed e.g. by an FPGA (FIG. 3b) or microcontroller, to yield an output Pdelay value. Processing may be in logic, and/or in embedded CPU software and/or in the FPGA or microcontroller of FIG. 3a. Implementation may be in software and/or in firmware, or a full hardware implementation may be employed.

Typically, the photodiode signal measured in FIG. 2 is fed to the FPGA or microcontroller of FIG. 3b (typically via an amplifier and comparator whose output signal (comp) is shown in FIG. 3b)). FIG. 3a′s FPGA, aka “filter ERR Pi filter P delay”, generates and outputs a Pdelay signal that is fed, in FIG. 1, to a line filter which outputs the hsync_gen signal of FIGS. 3a-3b, yielding “pixel_start” which may be a pixel timing output or time-stamp which governs timing of formation of light by the LDR (laser driver) of FIG. 1 which generates the impinging beam that typically strikes the moving mirror and (most of which) is reflected off toward the projection surface of FIG. 2.

Typically, once the apparatus of FIG. 2 yields the pd (photodetector output) signal, the electronics of FIGS. 3a-3b (and FIG. 4 which details an implementation of the s/w bloc of FIG. 3a) may be employed to convert the PD (photodetector output) signal generated in FIG. 2, into the Pdelay signal used in FIG. 1.

Reference is now made to FIGS. 5 and 6. To recall, FIG. 2 illustrates apparatus constructive and operative to determine Pdelay from measurements of a Photo Detector/photo-diode (PD). By way of example, FIG. 2 shows light impinging upon a MEMS and then on a projection surface e.g. screen. A response to light penetrating through a tiny hole located close to the end of X-FOV in the projected plane, may be measured by the photodetector, while the MEMS is moving at its resonance frequency. The x-dimension of the field of view of the laser projection system (which typically encompasses all or any portion of the projection surface) is shown by a double-headed arrow (X FOV) and, typically, there is an opening, e.g., groove or hole in the projection surface. The opening, through which light can pass, e.g. groove or hole, is typically positioned outside of the X FOV. Typically, the opening is a few mm in diameter, e.g., 1˜3 mm in diameter.

Typically, two pulses (rising and falling edges) result when the MEMS moving element (e.g. mirror) is in a position which is close to one extreme position of its X motion at a deterministic Y position (assuming, although this is not intended to be limiting, MEMS mirror movement in 2 DOFS e.g. X/Y).

It is appreciated that FIG. 2 is not intended to depict the precise location of the PD (photodetector). FIGS. 5 and 6, which are two alternative embodiments, show possible locations for the photodetector other than the solution shown in FIG. 2, and even these are not intended to be limiting.

FIG. 5 is a simplified side view illustration and optical diagram of a scanning mirror device according to an embodiment in which an internal photodetector is deployed atop a MEMS device, such as a MEMS Scanning Mirror e.g. MAR1110.X, MAR1200, typically in conjunction with a MEMS Controller aka mirror controller such as MAR2200, MAR2220, MAR2300, MAR4400 and/or a video controller such as MAR3200.

FIG. 6 is a simplified side view illustration and optical diagram of a scanning mirror device according to an alternative embodiment, in which an external photodetector is attached to the cover of a MEMS device, such as a MEMS Scanning Mirror e.g. MAR1110.X, MAR1200, typically in conjunction with a MEMS Controller aka mirror controller such as MAR2200, MAR2220, MAR2300, MAR4400 and/or a video controller such as MAR3200.

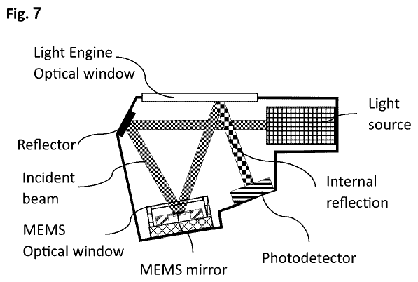

In FIGS. 5 and 6, the illustrated incident beam is generated by a light source, e.g., laser. Typically, most of the beam impinging on, then reflecting off from, the scanning mirror, goes through the window and impinges upon the projection surface (not shown). That portion of the beam, for simplicity, is not shown. However, a (typically much smaller) portion of the beam is, as shown in FIGS. 5 and 6, reflected back from the window (due to the imperfection of the window's anti-reflective coating). The photodiode may (as in FIG. 5) be deployed at a location where a portion of the beam is reflected back from the mirror's window (due to the imperfection of the window's anti-reflective coating). Or, a reflector may be positioned at that location (FIGS. 6, 7), to further reflect the portion of the beam that has been reflected back from the window, on to a photodetector deployed on the housing or cover or packaging.

In FIGS. 5 and 6, for simplicity, the MEMS motion sensor, the video controller, and the display screen, aka projection surface, are not shown. The window is typically a transparent protective member e.g. a transparent glass or plastic typically with an anti-reflective coating. It is appreciated that, even so, some light may be reflected from such a window or cover, although typically much less light than is transmitted through the window or cover which is generally transparent.

It is appreciated that the closed cycle control described herein, which compensates for typically temperature-related changes in pixel delay, is useful in even further improving pixel accuracy in state-of-the-art systems, such as but not limited to the laser projection systems of co-owned U.S. Pat. Nos. 9,769,444 and 11,606,540.

It is appreciated there may be at least the following 4 sources of delay in the system:
a. Pdelay aka Pixel delay; and/or
b. PD_delay aka Photodiode delay; and/or
c. data flow delay aka Data block computation delay and/or
d. “sensor delay” aka MEMS sensor delay

### Typically:

a. Pdelay=pixel delay, the aggregation of all delays in the system from the actual position of the MEMS to laser projection, e.g., from a moment that the MEMS reaches a certain position which corresponds to a given pixel or to a given position on a display screen, until the moment at which that pixel is generated due to (laser) light having been projected onto the pixel's position on the display screen Pdelay, includes the (typically relatively small) PD delay.

Pdelay may be thought of as system delay which, absent compensation according to embodiments herein, causes the laser driver to project a given pixel too late, causing unwanted discrepancy between MEMS mirror's actual position at a given time and position of the projected laser beam at the same time; the projected laser beam's position is supposed to coincide with the MEMS mirror's actual position.

Pdelay (e.g. in microseconds) may be estimated by comparing timing of two electrical signals e.g. the mirror sensor (aka optical sensor or photodetector) output and the photodiode output for the same input. For example, Pdelay may be as large as about 6 USEC in some temperatures.
a. Pdelay may be computed as a sum of the propagation delays of MEMS position sensing circuit, or source d above plus data flow delay (source c above).
b. PD_delay may refer to photodetector delay, the actual delay of the PD signal output. Typically, it is much smaller than Pdelay. This delay is typically fixed or constant, e.g., is typically not temperature-related.
c. Data flow delay may refer to delay internal to the video data flow block of FIG. 1. This delay is typically fixed or constant, e.g., is typically not temperature-related. Data flow delay may be computed or estimated as a delay from MEMS position sensing to actual laser projection.
d. Sensor delay is the MEMS position sensing delay (varies over time and/or as a function of ambient temperature)

Generally, delay, e.g. between a physical action in the real world and when this action is generated or perceived, is intended to include a time interval which corresponds, in a moving MEMS use case, to a distance between the position of the moving mirror at the beginning of the delay time interval [e.g. in mm or rad] and the same mirror's position at the end of the delay time-interval. It is appreciated that for (Pdelay), the first delay source discussed above, this delay may be the total time between the actual position (an example of a physical action) and when a light pulse is generated with respect to that position (perception of this action).

For delay sources b plus d (PD delay/Sensor)—this delay may be the time between the actual light passes on the PD or the actual position of the MEMS (an example of a physical action) and when an electrical pulse is generated with respect to the light pass or the position sensor (perception of this action).

For c (data flow delay)—this delay may be the time between the beginning of the data flow computing (example of a physical action) and when it is outputted e.g. generated.

Any parameters described herein may be pre-set in the factory, or may be configured via an API, in the field, or may be configured by an end-user, via a suitable user interface.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order, i.e., not necessarily as shown, including performing various operations in parallel or concurrently, rather than sequentially, as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine- readable media described herein is intended to include non-transitory computer-or machine-readable media.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively, or in addition, an alert may be provided to an appropriate human operator or to an appropriate external system.

Features or modules or elements of the present invention, including operations, which are described in the context of separate embodiments, may also be provided in combination in a single embodiment. A system embodiment is intended to include a corresponding process embodiment and vice versa. Features may also be combined with features known in the art, and particularly, although not limited to, those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

The disclosure includes any computer program product, comprising a non-transitory tangible computer readable medium having computer readable program code embodied therein, the computer readable program code adapted to be executed to implement any method described herein.

1. A laser projection system comprising:
a. a MEMS structure including
a moving mirror and
at least one MEMS motion sensor which sense the moving mirror's position; and
b. a photodetector which indicates the moving mirror's actual position by providing, at at least one time t, an output indication of light reflected from the mirror at time t which indicates that the moving mirror has reached a certain position p at said time t; and
c. a controller which, based on the sensor's time-stamps, provides control signals determining illumination of/which illuminates various locations of a projection surface aka display surface e.g. screen with illumination reflected off the moving mirror, wherein the location illuminated, within the display surface, varies as the mirror moves,
and wherein the controller estimates a delay, in provision of time-stamps for generation of pixels to be displayed on the projection surface, by comparing outputs of the MEMS motion sensor and of the photodetector, and, when controlling timing of the light source's illumination, takes into account or compensates for the delay as estimated.

2. The system of claim 1 wherein controlling timing of the light source's illumination, which takes into account the delay as estimated, comprises generating a time-stamp, by a controller, at which the light source is commanded to generate a given pixel, while taking into account the delay as estimated, including using the sensor's output as an estimate of the moving mirror's position over time, wherein said estimate is typically independent of said sensor.

3. The system of claim 1 wherein the display surface comprises an array of pixels comprising rows and columns, and wherein the moving mirror, which pivots, has roll in which the mirror pivots backward and forward about at an axis corresponding to a vertical midline of the display surface, defining an extreme backward position and an extreme forward position respectively corresponding to the two vertical sides (right and left edges e.g.) of the display surface, such that when the mirror is in its extreme backward position, illumination reflected therefrom illuminates a pixel in the right-most column of the display surface and when the mirror is in its extreme forward position, illumination reflected therefrom illuminates a pixel in the left-most column of the display surface.

4. The system of claim 1 wherein the display surface comprises an array of pixels comprising rows and columns, and wherein the moving mirror, which pivots, has pitch in which the mirror pivots backward and forward about at an axis corresponding to a horizontal midline of the display surface, defining an extreme backward position and an extreme forward position respectively corresponding to the top and bottom horizontal edges of the display surface, such that when the mirror is in its extreme backward position, illumination reflected therefrom illuminates a pixel in the topmost row of the display surface, and when the mirror is in its extreme forward position, illumination reflected therefrom illuminates a pixel in the bottom-most row of the display surface e.g. screen.

5. The system of claim 1 wherein the MEMS structure also comprises an optical cover which covers the mirror as a reflecting surface and wherein a portion of light impinging upon the optical cover is reflected back thereby to define cover-reflected light, and wherein the photodetector is positioned to receive the cover-reflected light at at least one time t, and, accordingly, to provide an output indication at time t which indicates that the moving mirror has reached, at time t, a position which causes the cover-reflected light to reach the photodetector.

6. The system of claim 1 wherein the controller computes a difference of d millisec between:
time t at which the photodetector identified that the moving mirror has reached position p; and
a time-stamp at which the sensor indicates that the moving mirror has reached position p,
and adds a bias of d millisec to the control signals that the controller provides to the light source.

7. The system of claim 1 wherein the photodetector comprises a photodiode.

8. The system of claim 1 wherein the surface Illumination controller comprises a video controller which computes a time stamp T for each pixel and, accordingly, controls data flow e.g. by causing a laser driver to generate, at time T, a pixel whose value corresponds to a stored pixel value.

9. The system of claim 1 wherein the light source comprises a laser.

10. A laser projection method comprising:
a. providing a MEMS structure including:
a moving mirror; and
at least one MEMS motion sensor which sense the moving mirror's position; and
b. providing and/or using a photodetector to indicate the moving mirror's actual position by providing, at at least one time t, an output indication of light reflected from the mirror at time t which indicates that the moving mirror has reached a certain position p at said time t; and
c. providing and/or using a controller which, based on the sensor's time-stamps, provides control signals determining illumination of/which illuminates various locations of a projection surface aka display surface e.g. screen with illumination reflected off the moving mirror, wherein the location illuminated, within the display surface, varies as the mirror moves,
and wherein the controller estimates a delay, in provision of time-stamps for generation of pixels to be displayed on the projection surface, by comparing outputs of the MEMS motion sensor and of the photodetector and, when controlling timing of the light source's illumination, takes into account or compensates for the delay as estimated.

11. The system of claim 1 wherein delay of position and/or speed sensing signals of the mirror with respect to the mirror's actual position, is automatically calibrated.

12. The system of claim 1 wherein light arriving at the photodetector is reflected from the light engine's optical window.

13. The system of claim 1 wherein delay in position and/or speed sensing signals of the mirror relative to the mirror's actual position is controlled by at least the MEMS controller.

14. The system of claim 1 wherein delay in position and/or speed sensing signals of the mirror, relative to the mirror's actual position, is controlled (e.g. estimated/computed, then compensated for/taken into account) by at least the video controller, thereby to provide closed-loop control.

15. The system of claim 1 wherein the moving mirror translates along a linear path.

16. The system of claim 1 wherein the photodetector is located within MEMS packaging encasing a silicon chip which comprises a MEMS structure implementing at least the mirror of said laser projection system.

17. The system of claim 1 wherein the photodetector is part of a silicon chip which comprises a MEMS structure implementing at least the mirror of said laser projection system.

18. The system of claim 1 wherein light arriving at the photodetector is reflected from the MEMS package optical window or cover.
